(19) United States
(12) Patent Application Publication
(10) Pub. No.: US 2024/0149973 A1
(43) Pub. Date: May 9, 2024

(54) BICYCLE PEDAL

(71) Applicant: Chin-Long Hsieh, Taichung City (TW)

(72) Inventor: Chin-Long Hsieh, Taichung City (TW)

(21) Appl. No.: 18/206,017

(22) Filed: Jun. 5, 2023

(30) Foreign Application Priority Data
Nov. 4, 2022 (TW) 111142244

(51) Int. Cl. B62M 3/10; B62M 3/08

(52) U.S. Cl. CPC B62M 3/10; B62M 3/086

(57) ABSTRACT

A bicycle pedal includes a shaft seat, a shaft, a first pedal element and a second pedal element. The shaft seat has a shaft hole, a first threaded hole and a second threaded hole. The first threaded hole and the second threaded hole are separately located at symmetrical positions on two sides of an axis line of the shaft hole. The shaft is rotatably disposed in the shaft hole of the shaft seat. An end of the shaft has a thread for connecting with a crank. The first pedal element and the second pedal element are fixed to the first threaded hole and the second threaded hole by a first bolt and a second bolt, respectively. The first pedal element and the second pedal element are separately disposed at symmetrical positions on two sides of the shaft.

### BACKGROUND

### Technical Field

The invention relates to bicycle pedals, particularly to a bicycle pedal with two-tone appearance.

### Related Art

A conventional bicycle pedal includes a pedal element and a shaft. The pedal element is formed with a shaft hole and the shaft is rotatably disposed in the shaft hole. The pedal is threaded into a bicycle crank. The pedal is the part of a bicycle that the rider pushes with their foot to propel the vehicle. It provides the connection between the cyclist's foot or shoe and the crank allowing the leg to turn the bottom bracket spindle and propel the bicycle's wheels.

Traditional pedal elements usually adopt a single material and a one-piece design, usually plastic or metal (such as aluminum).

In comparison with an all-metal pedal element, an all-plastic pedal element has advantages of lightweight, many color changes, being easy to be variously shaped and low costs, but its drawbacks are insufficient strength (easy to be fractured or damaged) and poor wet friction (the friction between the pedal element and a sole will be lowered by water).

### SUMMARY

An object of the invention is to provide a bicycle pedal which may have two-tone appearance and multiple functions.

To accomplish the above object, the invention provides a bicycle pedal, which includes a shaft seat, a shaft, a first pedal element and a second pedal element. The shaft seat has a shaft hole, a first threaded hole and a second threaded hole. The first threaded hole and the second threaded hole are separately located at symmetrical positions on two sides of an axis line of the shaft hole. The shaft is rotatably disposed in the shaft hole of the shaft seat. An end of the shaft has a thread for connecting with a crank. The first pedal element and the second pedal element are fixed to the first threaded hole and the second threaded hole by a first bolt and a second bolt, respectively. The first pedal element and the second pedal element are separately disposed at symmetrical positions on two sides of the shaft.

As a preferred embodiment of the invention, symmetrical positions on two sides of the shaft of the shaft seat are separately formed with a first dovetail block and a second dovetail block, the first pedal element has a first dovetail trough matching the first dovetail block, and the second pedal element has a second dovetail trough matching the second dovetail block. The first pedal element has a first stepping face and a second stepping face, which are located on two opposite surfaces. The second pedal element has a third stepping face and a fourth stepping face, which are located on two opposite surfaces. The first stepping face and the third stepping face are located on the same side of the shaft, and the second stepping face and the fourth stepping face are located on the same side of the shaft.

As another preferred embodiment of the invention, the first pedal element has an upper stepping face and a first connecting face, which are separately located on two opposite sides of the first pedal element. The upper stepping face is used for being stepped by a shoe. The second pedal element has a lower stepping face and a second connecting face, which are separately located on two opposite sides of the second pedal element. The lower stepping face is used for being stepped by a shoe. The first stepping face and the lower stepping face are separately located on two opposite sides of the shaft. The first connecting face and the second connecting face face to each other.

An edge of the first connecting face has multiple protrusions projecting toward the second connecting face, and positions of the second connecting face, which correspond to the protrusions, are disposed with multiple recesses matching with the protrusions. The shaft seat is sandwiched between the first pedal element and the second pedal element and then the shaft seat, the first pedal element and the second pedal element are assembled by the first bolt and the second bolt to be a sandwich structure.

As still another preferred embodiment of the invention, the shaft seat has a first engaging block and a second engaging block at symmetrical positions on two sides of the shaft. Each of the first engaging block and the second engaging block is a rectangular block. The first engaging block and the second engaging block separately oppositely project along a radial direction of the shaft seat. The first engaging block and the second engaging block are disposed with a first threaded hole and the second threaded hole, respectively. The first pedal element has a first engaging trough matching the first engaging block. The second pedal element has a second engaging trough matching the second engaging block. The first pedal element has a first stepping face and a second stepping face, which are separately located on two opposite sides thereof. The second pedal element has a third stepping face and a fourth stepping face, which are separately located on two opposite sides thereof. The first stepping face and the third stepping face are located on the same side of the shaft. The second stepping face and the fourth stepping face are located on the same side of the shaft.

As yet another preferred embodiment of the invention, it further includes a fastener for fixing a cycling shoe. The fastener is screwed to the first threaded hole and/or the second threaded hole.

Advantages and functions of the bicycle pedal of the invention are: the main body of the pedal of the invention is composed of the shaft seat, the first pedal element and the second pedal element, the pedal of the invention which is composed of three parts has variability, the first pedal element and the second pedal element can be separately coated with different colors to be a pedal with two tones, and they are easy to be changed.

As a preferred embodiment of the invention, the first pedal element and the second pedal element are made of an aluminum alloy. Preferably, the first pedal element and the second pedal element, which are made of an aluminum alloy, become anodized aluminum through anodic oxidation treatment, and then through the dyeing process to form a required color on the surface. For example, the first pedal element and the second pedal element may be coated with different colors to be a bicycle pedal with two tones.

On the other hand, the shaft seat is disposed with a first threaded hole and a second threaded hole. Besides for assembling of the first pedal element and the second pedal element, the positions of the first threaded hole and the second threaded hole also match the size of a cleat on a cycling shoe so as to allow an exclusive cleat to be applied to the bicycle pedal of the invention. This accomplishes multiple functions.

### BRIEF DESCRIPTION OF THE DRAWINGS

FIG. 1 is a perspective view of the first embodiment of the bicycle pedal of the invention;

FIG. 2 is an exploded view of the first embodiment of the bicycle pedal of the invention;

FIG. 3 is a perspective view of the second embodiment of the bicycle pedal of the invention;

FIG. 4 is an exploded view of the second embodiment of the bicycle pedal of the invention;

FIG. 5 is a perspective view of the third embodiment of the bicycle pedal of the invention;

FIG. 6 is an exploded view of the third embodiment of the bicycle pedal of the invention;

FIG. 7 is a perspective view of the fourth embodiment of the bicycle pedal of the invention; and

FIG. 8 is an exploded view of the fourth embodiment of the bicycle pedal of the invention.

### DETAILED DESCRIPTION

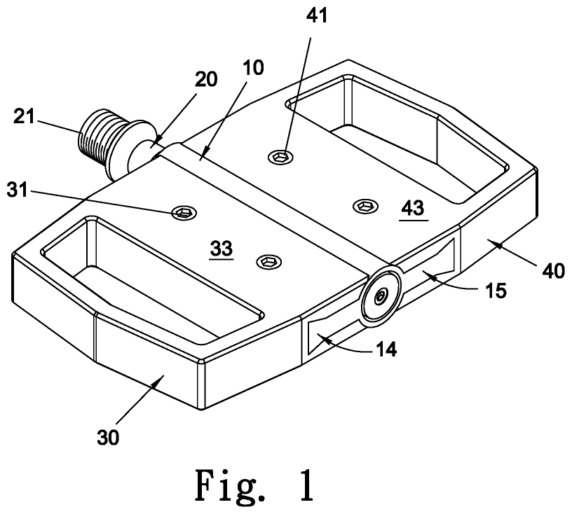

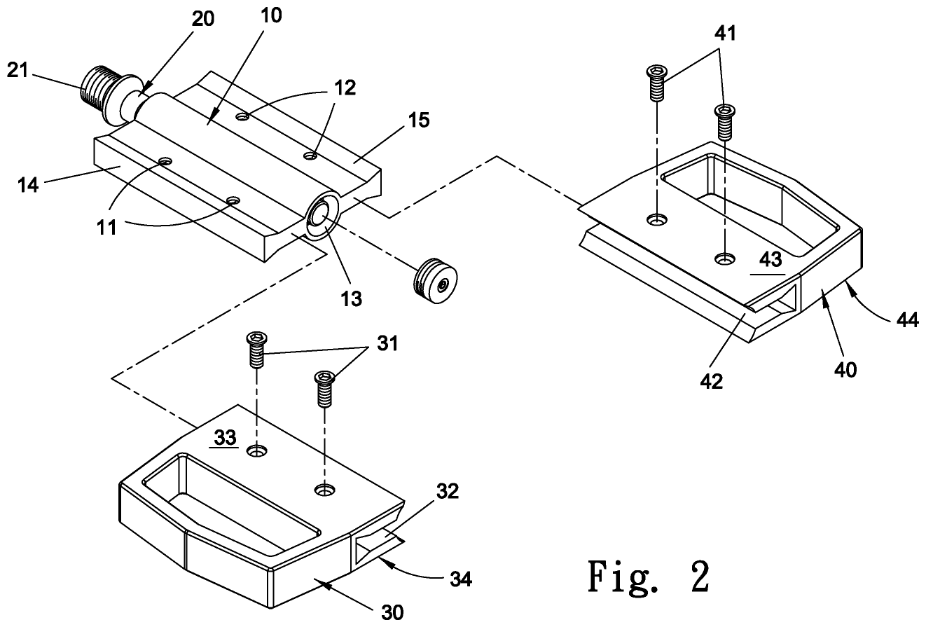

Please refer to FIGS. 1 and 2, which are a perspective view and an exploded view of the first embodiment of the bicycle pedal of the invention, respectively. The invention provides a bicycle pedal for connecting with a crank to be stepped by a cyclist. The pedal includes a shaft seat 10, a shaft 20, a first pedal element 30 and a second pedal element 40.

The shaft seat 10 has a shaft hole 13, a first threaded hole 11 and a second threaded hole 12. The first threaded hole 11 and the second threaded hole 12 are separately located at symmetrical positions on two sides of an axis line of the shaft hole 13. The shaft 20 is rotatably disposed in the shaft hole 13 of the shaft seat 10. An end of the shaft 20 has a thread 21 for connecting with a crank (not shown). The first pedal element 30 and the second pedal element 40 are fixed to the first threaded hole 11 and the second threaded hole 12 by a first bolt 31 and a second bolt 41, respectively. The first pedal element 30 and the second pedal element 40 are separately disposed at symmetrical positions on two sides of the shaft 20. Preferably, the first pedal element 30 and the second pedal element 40 are of an axially symmetrical structure (an axis line of the shaft 20 serves as a symmetrical axis).

In the first embodiment of the invention, the first pedal element 30 and the second pedal element 40 are separately disposed at symmetrical positions on two sides of the shaft 20. In detail, under a normal status, when a user steps on the bicycle pedal of the invention, the relative position of the first pedal element 30 and the second pedal element 40 is one behind the other (the forward riding direction of a bicycle is front). As shown in FIGS. 1 and 2, symmetrical positions on two sides of the shaft 20 of the shaft seat 10 are separately formed with a first dovetail block 14 and a second dovetail block 15, the first pedal element 30 has a first dovetail trough 32 matching the first dovetail block 14, and the second pedal element 40 has a second dovetail trough 42 matching the second dovetail block 15. The first pedal element 30 has a first stepping face 33 and a second stepping face 34, which are located on two opposite surfaces. The second pedal element 40 has a third stepping face 43 and a fourth stepping face 44, which are located on two opposite surfaces. The first stepping face 33 and the third stepping face 43 are located on the same side of the shaft 20, and the second stepping face 34 and the fourth stepping face 44 are located on the same side of the shaft 20. As a preferred embodiment, the sliding directions of the first dovetail block 14 and the second dovetail block 15 are parallel to the axis line of the shaft hole 13. After the first pedal element 30 has been assembled by the first dovetail trough 32 and the first dovetail block 14, the first bolt 31 passes through the first dovetail trough 32 of the first pedal element 30 and then is screwed with the first threaded hole 11 in the first dovetail block 14. Identically, after the second pedal element 40 has been assembled by the second dovetail trough 42 and the second dovetail block 15, the second bolt 41 passes through the second dovetail trough 42 of the second pedal element 40 and then is screwed with the second threaded hole 12 in the second dovetail block 15. As a preferred embodiment, the number of each of the first bolt 31, the first threaded hole 11, the second bolt 41 and the second threaded hole 12 is two for providing better assembling quality.

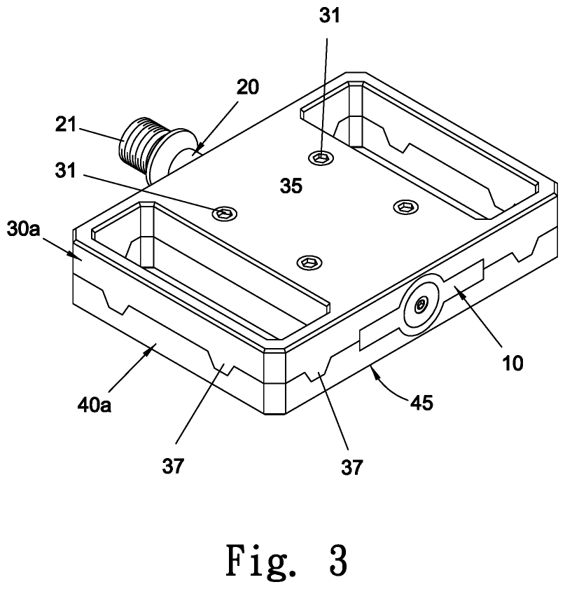

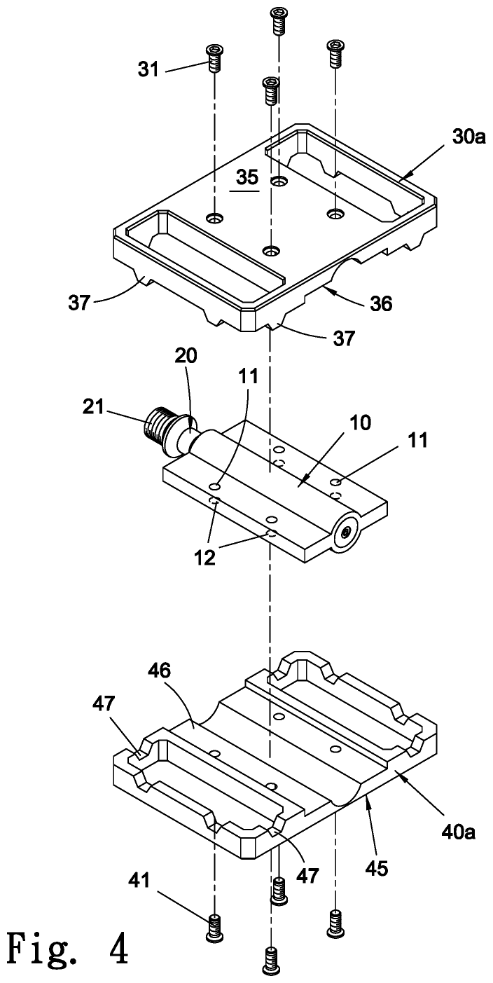

Please refer to FIGS. 3 and 4, which are a perspective view and an exploded view of the second embodiment of the bicycle pedal of the invention, respectively. The second embodiment differs from the first embodiment by the shaft seat 10 of the second embodiment being sandwiched between the first pedal element 30a and the second pedal element 40a and using the first bolt 31 and the second bolt 41 to fix the shaft seat 10, the first pedal element 30a and the second pedal element 40a together to form a sandwich structure. The first pedal element 30a has an upper stepping face 35 and a first connecting face 36, which are separately located on two opposite sides of the first pedal element 30a. The upper stepping face 35 is used for being stepped by a shoe. The second pedal element 40a has a lower stepping face 45 and a second connecting face 46, which are separately located on two opposite sides of the second pedal element 40a. The lower stepping face 45 is used for being stepped by a shoe. The first stepping face 35 and the lower stepping face 45 are separately located on two opposite sides of the shaft 20. The first connecting face 36 and the second connecting face 46 face each other. Under a normal status, the relative position of the first pedal element 30a and the second pedal element 40a is one under the other. For example, when some shoe of a user steps on the upper stepping face 35 of the first pedal element 30a, the lower stepping face 45 of the second pedal element 40a will face on the ground without being stepped by a shoe.

As a preferred embodiment of the invention, an edge of the first connecting face 36 has multiple protrusions 37 projecting toward the second connecting face 46, and positions of the second connecting face 46, which correspond to the protrusions 37, are disposed with multiple recesses 47 matching with the protrusions 37. The shaft seat 10 is sandwiched between the first pedal element 30a and the second pedal element 40a and then the shaft seat 10, the first pedal element 30a and the second pedal element 40a are assembled by the first bolt 31 and the second bolt 41 to be a sandwich structure. Parts of the first connecting face 36 and the second connecting face 46 are connected with each other. The structural assembled strength of the first pedal element 30a and the second pedal element 40a can be reinforced by the engagement between the protrusions 37 and the recesses 47.

As a preferred embodiment of the invention, the first pedal element 30, 30a and the second pedal element 40, 40a are made of an aluminum alloy. Preferably, the first pedal element 30, 30a and the second pedal element 40, 40a, which are made of an aluminum alloy, become anodized aluminum through anodic oxidation treatment, and then through the dyeing process to form a required color on the surface. For example, the first pedal element 30,30a, and the second pedal element 40, 40a may be coated with different colors to be a bicycle pedal with two tones.

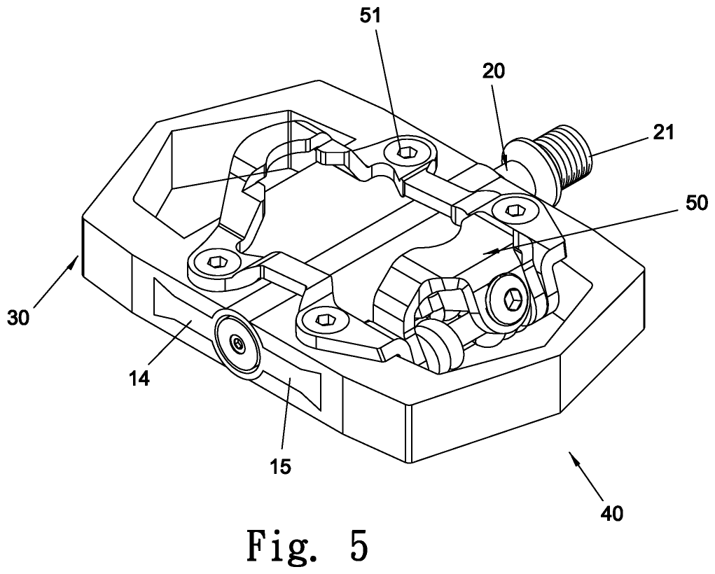

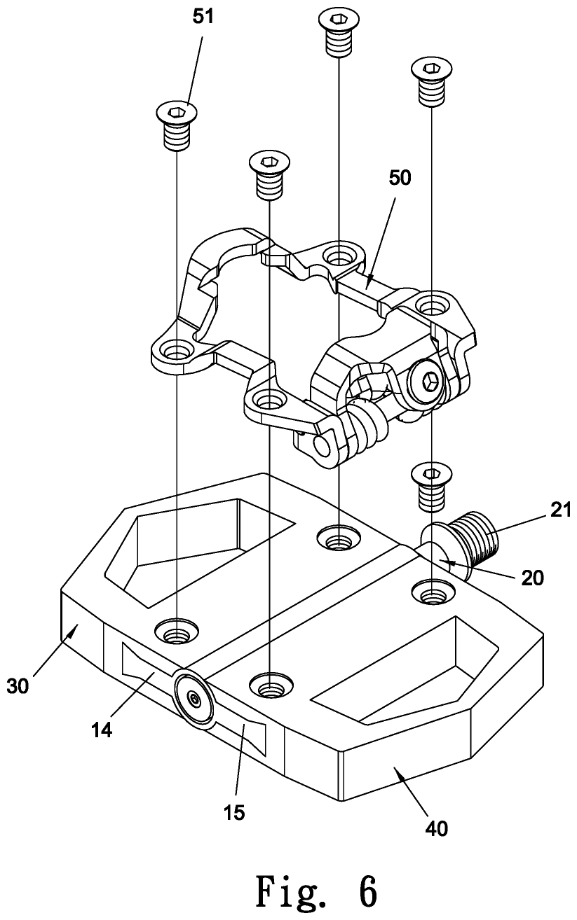

Please refer to FIGS. 5 and 6, which are a perspective view and an exploded view of the third embodiment of the bicycle pedal of the invention, respectively. The embodiment further includes a fastener 50. The fastener 50 is screwed with the first threaded hole 11 and/or the second threaded hole 12. The fastener 50 may adopt a road-bike type or a mountain-bike type. Besides for assembling of the first pedal element 30, 30a and the second pedal element 40, 40a, the positions of the first threaded hole 11 and the second threaded hole 12 also match the size of a fastener 50 on a cycling shoe so as to allow an exclusive fastener 50 to be applied to the bicycle pedal of the invention. This accomplishes multiple functions.

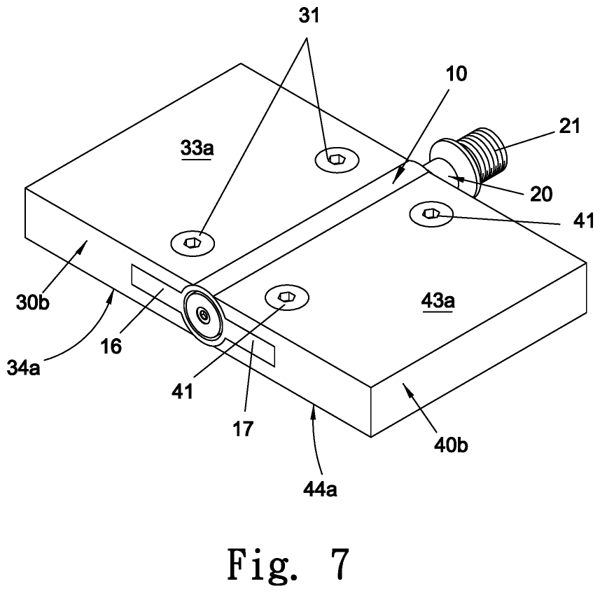

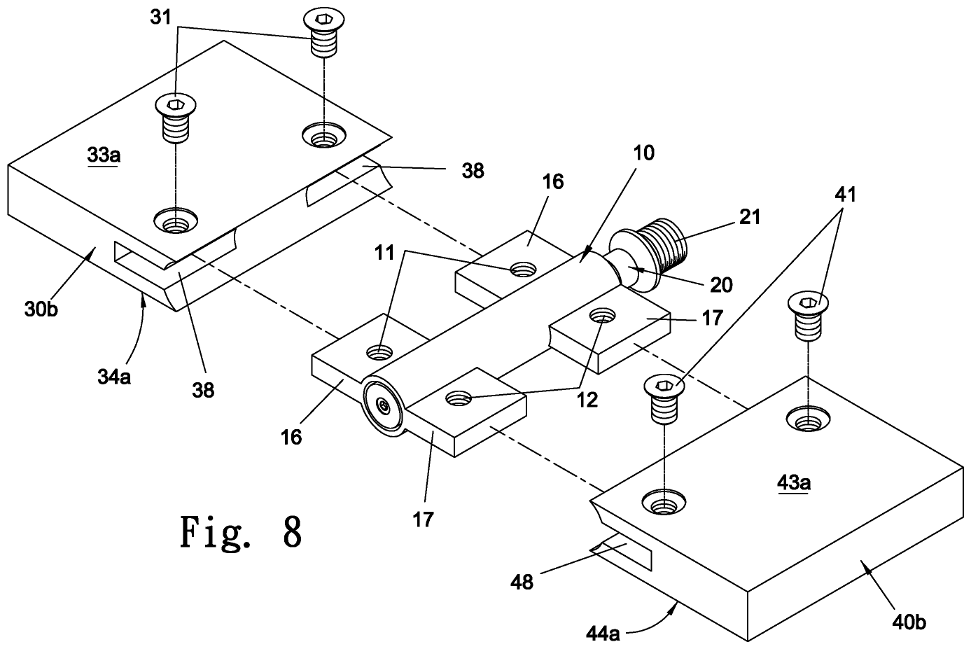

Please refer to FIGS. 7 and 8, which are a perspective view and an exploded view of the fourth embodiment of the bicycle pedal of the invention, respectively. The shaft seat 10 has a first engaging block 16 and a second engaging block 17 at symmetrical positions on two sides of the shaft 20. Each of the first engaging block 16 and the second engaging block 17 is a rectangular block. The first engaging block 16 and the second engaging block 17 separately oppositely project along a radial direction of the shaft seat 10. The first engaging block 16 and the second engaging block 17 are disposed with a first threaded hole 11 and the second threaded hole 12, respectively. The first pedal element 30b has a first engaging trough 38 matching the first engaging block 16. The second pedal element 40b has a second engaging trough 48 matching the second engaging block 17. The first pedal element 30b has a first stepping face 33a and a second stepping face 34a, which are separately located on two opposite sides thereof. The second pedal element 40b has a third stepping face 43a and a fourth stepping face 44a, which are separately located on two opposite sides thereof. The first stepping face 33a and the third stepping face 43a are located on the same side of the shaft 20. The second stepping face 34a and the fourth stepping face 44a are located on the same side of the shaft 20. The first pedal element 30b and the second pedal element 40b engage with the first engaging block 16 and the second engaging block 17 from the front side and the rear side of the shaft seat 10, respectively, and then the first bolt 31 and the second bolt 41 are used for assembling and fixing.

While this disclosure has been described by means of specific embodiments, numerous modifications and variations could be made thereto by those skilled in the art without departing from the scope and spirit of this disclosure set forth in the claims.

What is claimed is:

1. A bicycle pedal connected to a crank, comprising:
a shaft seat, having a shaft hole, a first threaded hole and a second threaded hole, and the first threaded hole and the second threaded hole being separately located at symmetrical positions on two sides of an axis line of the shaft hole;
a shaft, rotatably disposed in the shaft hole of the shaft seat, and an end of the shaft having a thread for connecting with the crank;
a first pedal element; and
a second pedal element;
wherein the first pedal element and the second pedal element are fixed to the first threaded hole and the second threaded hole by a first bolt and a second bolt, respectively, and the first pedal element and the second pedal element are separately disposed at symmetrical positions on two sides of the shaft.

2. The bicycle pedal of claim 1, wherein symmetrical positions on two sides of the shaft of the shaft seat are separately formed with a first dovetail block and a second dovetail block, the first pedal element has a first dovetail trough matching the first dovetail block, the second pedal element has a second dovetail trough matching the second dovetail block, the first pedal element has a first stepping face and a second stepping face, which are located on two opposite surfaces, the second pedal element has a third stepping face and a fourth stepping face, which are located on two opposite surfaces, the first stepping face and the third stepping face are located on the same side of the shaft, and the second stepping face and the fourth stepping face are located on the same side of the shaft.

3. The bicycle pedal of claim 1, wherein the first pedal element has an upper stepping face and a first connecting face, which are separately located on two opposite sides of the first pedal element, the upper stepping face is used for being stepped by a shoe, the second pedal element has a lower stepping face and a second connecting face, which are separately located on two opposite sides of the second pedal element, the lower stepping face is used for being stepped by a shoe, the first stepping face and the lower stepping face are separately located on two opposite sides of the shaft, and the first connecting face and the second connecting face face to each other.

4. The bicycle pedal of claim 3, wherein an edge of the first connecting face has multiple protrusions projecting toward the second connecting face, positions of the second connecting face, which correspond to the protrusions, are disposed with multiple recesses matching with the protrusions, the shaft seat is sandwiched between the first pedal element and the second pedal element, and the shaft seat, the first pedal element and the second pedal element are assembled by the first bolt and the second bolt to be a sandwich structure.

5. The bicycle pedal of claim 1, wherein the shaft seat has a first engaging block and a second engaging block at symmetrical positions on two sides of the shaft, each of the first engaging block and the second engaging block is a rectangular block, the first engaging block and the second engaging block separately oppositely project along a radial direction of the shaft seat, the first engaging block and the second engaging block are disposed with a first threaded hole and the second threaded hole, respectively, the first pedal element has a first engaging trough matching the first engaging block, the second pedal element has a second engaging trough matching the second engaging block, the first pedal element has a first stepping face and a second stepping face, which are separately located on two opposite sides thereof, the second pedal element has a third stepping face and a fourth stepping face, which are separately located on two opposite sides thereof, the first stepping face and the third stepping face are located on the same side of the shaft, and the second stepping face and the fourth stepping face are located on the same side of the shaft.

6. The bicycle pedal of claim 1, further comprising a fastener for fixing a cycling shoe, wherein the fastener is screwed to the first threaded hole and/or the second threaded hole by a bolt.
